(19) United States
(12) Patent Application Publication
(10) Pub. No.: US 2014/0026474 A1
(43) Pub. Date: Jan. 30, 2014

(54) AUTOMATED GROW SYSTEM

(71) Applicant: Charles J. Kulas, San Francisco, CA (US)

(72) Inventor: Charles J. Kulas, San Francisco, CA (US)

(21) Appl. No.: 13/830,221

(22) Filed: Mar. 14, 2013

Related U.S. Application Data
(60) Provisional application No. 61/675,767, filed on Jul. 25, 2012.

(51) Int. Cl. A01G 9/02

(52) U.S. Cl. CPC A01G 9/02
USPC 47/1.7

(57) ABSTRACT

Embodiments generally relate to a system for growing plants or other living organisms. A container is used that includes sensors for sensing conditions of the plant. Dispensers, such as emitters, provide a way to dispense materials such as water, nutrients, insecticides, herbicides, etc. under human or machine control. A network connection allows monitoring and control of the container from a remote site. Management of plant growth can be local or remote, or a combination of the two. Control expertise can be selected by a user who is local to the container from a website. Control expertise can also be provided by a human expert who is remote from the container. Other features are described.

### CROSS REFERENCES TO RELATED APPLICATIONS

This application claims priority from U.S. Provisional Patent Application Ser. No. 61/675,767, entitled AUTOMATED GROW SYSTEM, filed on Jul. 25, 2012, which is hereby incorporated by reference as if set forth in full in this application for all purposes.

### BACKGROUND

This invention relates in general to growing plants and more specifically to growing plants in a small, self-contained environment that includes remote monitoring and control.

Growing plants can provide food, herbs and spices, medicine and other health benefits, ornamentation or decoration, entertainment and other benefits. However, some types of plant species can be difficult to take care of and grow properly. In some cases the natural environment may not be adequate for the plant. For example, the ambient weather may be too cold or hot. The plant may be subjected to the wrong amount of sunlight, rain, humidity, wind or other weather conditions. There may be insects, fungus, weeds or other intruding vegetation; disease or other hostile conditions for a plant. Although materials such as fertilizers, insecticides, herbicides, water and other materials can be applied, it may require special knowledge to apply the right materials at the right times in the right amounts.

Some plants may require special skill or knowledge to grow properly. Plant care and maintenance can include trimming, replanting, rotating different plants to maintain soil nutrients, etc. Another drawback with growing plants is that many people who live in modern areas do not have enough space to grow the type or quantity of plants that they desire.

### SUMMARY

A container is used that includes sensors for sensing conditions of the plant. Dispensers, such as emitters, provide a way to dispense materials such as water, nutrients, insecticides, herbicides, etc. under human or machine control. A network connection allows monitoring and control of the container from a remote site. Management of plant growth can be local or remote, or a combination of the two. Control expertise can be selected by a user who is local to the container from a website. Control expertise can also be provided by a human expert who is remote from the container. Other features are described.

One embodiment provides an apparatus for growing a plant, the apparatus comprising an enclosure; a sensor for sensing a condition of a plant inside the enclosure; a dispenser for applying a material to the plant; a receptacle associated with the enclosure and coupled to the dispenser for dispensing the material to the plant; and a communication module for transmitting the sensor signal over the Internet and for receiving a signal from the Internet to control dispensing of the material to the plant in response to the sensor signal.

### BRIEF DESCRIPTION OF THE DRAWINGS

FIG. 1 shows details of an embodiment of a personal grower; and

FIG. 2 shows a personal grow system embodiment including networked devices.

### DETAILED DESCRIPTION

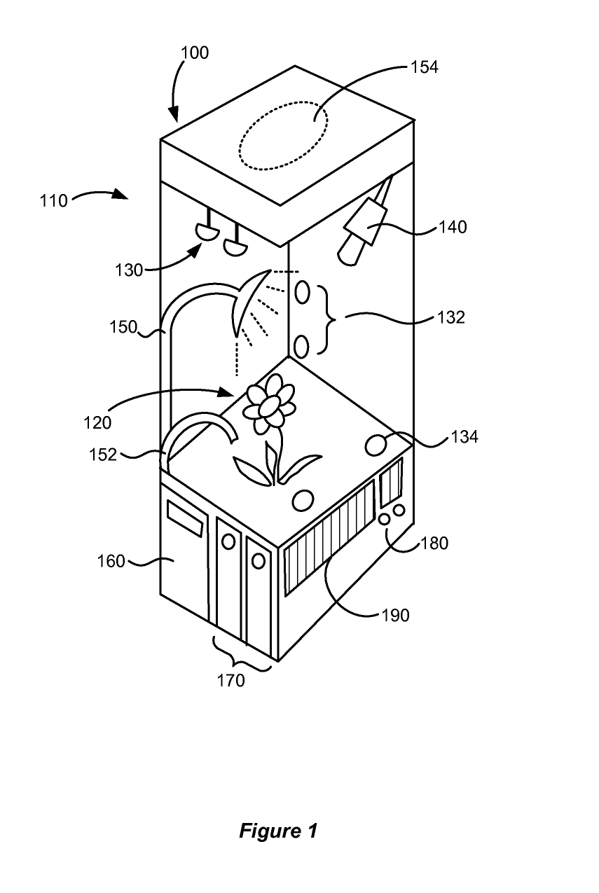

FIG. 1 shows details of an embodiment of a personal grow system. In FIG. 1, personal grower 100 includes an enclosure 110. Enclosure 110 houses one or more plants such as plant 120. Note that plant 120 can be any number or type of plant or vegetation. For ease of illustration a single plant is shown. Enclosure 110 can include one or more types of sensors such as sensors 130-134, camera 140, etc.; and emitters such as applicators 150, 152; sun lamp 154, etc. Different configurations of sensors and emitters can be provided as an assembled product, kit, or as after-market add-ons.

In a particular embodiment, the enclosure is small enough to fit on a typical kitchen countertop without taking up too much space. For example a dimension of 1 foot square by 1 to 3 feet high. It should be apparent that many other dimensions are possible and would work with many of the features described herein. In a particular embodiment the height of the enclosure is variable and can extend upward as the plant grows. For example, the sides can be made of transparent plastic in an “accordion” design so that telescoping rods on each of the four corners can be extended to raise the top of the enclosure as the plant grows. Other designs can use a fixed height.

Enclosures can be extendable in other dimensions such as by allowing different size trays to be placed onto the bottom of the enclosure in FIG. 1. An enclosure need not be completely enclosed. In some designs one or more sides can be omitted so that the enclosure is only a partial enclosure and the plant or other vegetation is subjected to the open air. The enclosure can be made of any suitable materials. In some cases, enclosures can be connected to external material supplies such as using a tube or hose to route water from a spigot to a connection on the enclosure. Similarly, other materials can be connected to the enclosure's emitters or dispensers so that the emitters and dispensers can be supplied from larger sources than might otherwise fit within the enclosure.

Although a rectangular enclosure is depicted, any other suitable shape can be used. In some applications, for example, it may be desirable to have a spherical shape, or an inverted pyramid shape, etc., to accommodate the shape of a mature plant.

Sensors can include any type of sensor now know or to be discovered in the future. For example, some types of sensors include those that sense temperature, humidity, air pressure, oxygen, carbon dioxide or other gas or chemical sensors, sap flow, light, plant water potential, ceptometers, canopy analyzers, dendrometers, radiometers, spectrometers, porometers, fluorescence and reflectance sensors, plant hydraulic conductance meters, leaf area meters, leaf wetness sensors, photosynthesis, plant temperature sensors, root scanning, infra-red, thermometers, tree health, wood properties, DNA sensors, etc. Such sensors can be implemented by any suitable means known in the art or discovered in the future.

Materials for the emitters can include water, nutrients, insecticides, herbicides, etc. The types of emitters and the manner in which the materials are dispensed via the emitters can be by any suitable means. In general, the selection, installation and control of sensing and emitting operations can be as desired in different embodiments. Any suitable type of dispenser mechanism can be used rather than specific emitter types disclosed herein.

In FIG. 1, sensors are shown mounted at different points on the enclosure. For example, sensors 130 are mounted at the top of the enclosure while sensors 132 are mounted along a side support and sensor 134 is mounted at the bottom of the inside of the enclosure. Any suitable place for mounting or positioning a sensor is possible. For example, sensors may be mounted on the outside of the enclosure. Sensors can also be external to the enclosure yet positioned to sense a condition within or adjacent to the enclosure such as overall plant size using an external imaging device such as a camera, or external air temperature or rain sensor to sense a condition of the environment outside of the enclosure.

In a particular embodiment, one or more sensors can be attached in a desired location such as by mechanically affixing, using an adhesive, etc. The sensor can be a stand-alone sensor that is provided with a battery and wired or wireless communication means to a local controller in, at or near to the enclosure. Each stand-alone sensor registers itself with the local controller and communicates with the local controller to provide sensor data for use in reporting or recording data, or for or controlling dispensing of a material.

Emitters can also be stand alone and can register with and be controlled via a local controller. For example, sun lamp 154 can be a self-contained stand-alone device that mounts to the top of the enclosure and has its own power source. In such a case, sun lamp 154 can be in wired or wireless communication with the local controller. In general, any suitable manner of affixing, communicating with, or controlling sensors and emitters can be used.

The local controller can be a general purpose computer system, customized processing system, or other suitable control means. The local controller can use a general purpose central processing unit (CPU) along with storage device and communication hardware. The local controller can include dedicated hardware, or a combination of dedicated hardware and general purpose computing system. In some embodiments the local controller need not process signals locally but can simply act to transfer the signals to other devices over a network so that the other devices (local or remote devices) can perform sensing, control, monitoring and other operations. In general, any suitable device or combination of computing devices may be used to implement the control function or other operations. For example, a laptop, desktop, tablet, phone, gaming device, etc., can be used.

As conditions of the plant or the plant's environment are sensed, the sensor data is sent to a control program being executed by a digital processor. The control program in turn uses the sensor information to send signals to the emitters to control dispensing or effects on the plant or its environment. In order to make the personal grower compact and self-sustaining, one or more of the materials can be stored in receptacles that are built into, adjacent to or locally provided to the enclosure. For example, water drawer 160 can be filled with water for dispensing by applicator 150 under program control. Insecticides, herbicides, nutrients or other chemicals can be placed in drawers such as 170 for dispensing by applicators or other emitters.

In a particular embodiment, personal grower 100 is provided with attached controls 180 and display 170. These controls can be used, for example, for manually forcing dispensing of certain materials, modifying parameters of a control program, setting variable such as type of plant, date/time, geographic location, type of control program to use, etc. Display 190 can be used to show the current dispensing schedules, sensor readings, plant growth history, projected plant growth, level of nutrients, etc. Many other control functions can be implemented with attached controls. Control functions can also be performed by connecting a computer, cell phone or other device to communication circuits associated with the enclosure to configure, monitor and control the various sensors and emitters.

In a particular embodiment, chemicals or nutrients are requested to be loaded by a human user by displaying a message on display 190. The user can select communication via any other suitable device so that, for example, a message may appear on a user's cell phone. The message can be by email, text, Twitter™, Facebook™, post, notification, phone call, chat or any other suitable type of message. The user may fill the drawer (or other receptacle) with the material by pouring more of the material into the drawer. The drawer or receptacle can have a sensor that shows the level of the material and can even sense the type of material.

In one embodiment, the user can be provided with “packs” or “cartridges” of materials in pre-packaged form. Obtaining such cartridges can be by online ordering or mail ordering. Orders for the proper type and amount of materials (whether in cartridge form or not) can be automated in whole or in part by having the local controller send the order request to a central supplier. Once loaded, a code on the cartridge can be sensed by a sensor built into the drawer or receptacle so that the local controller is aware that the proper material has been inserted and that the cartridge is new. Other information about the materials to be dispensed can be sensed by the personal grower as desired. For example, a prepared-on date, expiration date, brand or manufacturer, quantity, etc. can be detected. Detection can be by optical character recognition (OCR), bar code scanning, radio-frequency identification (RFID), quick response (QR) code, or by any suitable automated means. Identification can also be done manually by having the user type in an identifying number on the attached control panel or on another device.

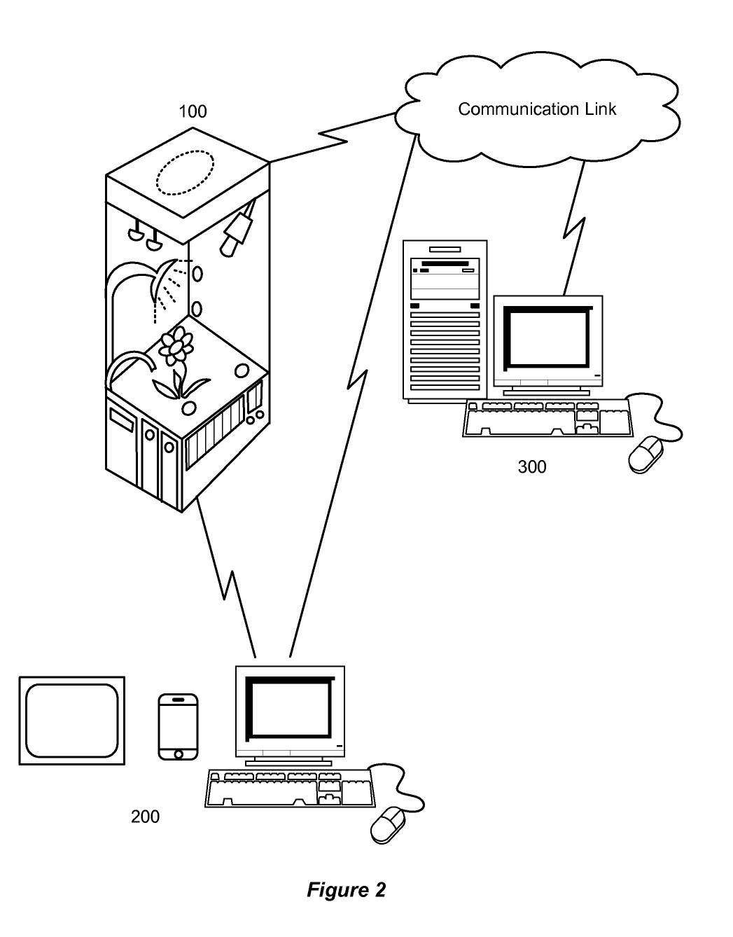

FIG. 2 shows a personal grow system embodiment including networked devices. In FIG. 2, grow system 100 is in communication with other devices such as user devices 200 and “expert” devices 300. User devices can include any personal type of computer, telecommunication or other electronic device. User devices 200 can be in direct communication with grow system 100 such as by using Bluetooth, Wi-Fi, Ethernet, or other types of communication. User devices 200 can also be in communication with the grow system via the Internet, cellular voice or data networks, local area network (LAN) or other suitable communication links.

Similarly, expert devices such as a server computer, desktop computer, cell phone, etc., are in communication with the grow system and with the user devices—typically via a suitable network such as the Internet, wide area network (WAN), radio or cell phone network, etc. In general, any type of communication links and protocols can be used to transfer information among the devices show in FIG. 2.

The tasks of sensing, control, dispensing, data logging, predicting, and other tasks can be performed at any of the 3 locations (grow system, user devices, expert devices) or by yet other devices at different locations (not shown). In a particular embodiment, a user is able to request a plant grow profile by specifying the type of plant that the user has placed in the enclosure. Another way to identify the plant is to have one of the devices scan a label or package (e.g., a seed package) associated with the plant. Or if the plant is sufficiently sprouted a photo or video can be used for image recognition to automatically determine the plant from the image(s).

Once the type of plant has been identified, the appropriate profile can be assigned to the grow system. Each grow system can have an identifying number so that many grow systems' profiles and performances can be tracked. The profiles can be provided by the expert's server. The profiles can be pre-determined and different expert sources can provide/sell different profiles. The profiles can provide schedules for application of particular materials and conditions to aid in plant growth. The profiles can be changed from time-to-time by the expert's hardware or by a human expert. Similarly, the user can switch, stop or modify the profiles. If a profile is not yielding expected results (as indicated by failure to meet sensed conditions such as plant height, leaf canopy, gross leaf area, budding, flowering, overall plant structure, etc.) the expert and/or user can be alerted to intervene and take action to change the profile.

Daily reports or alerts can be provided to the user so that the user can see a current image of the plant (as taken by, for example, camera 140 of FIG. 1) along with statistics and past and present sensor readings so that the user is informed of the plant's growth and of the grow system's performance. Execution of the profile instructions can be by any one or more of the devices contemplated in FIG. 2, or by other suitable devices (not shown).

Although the description has been described with respect to particular embodiments thereof, these particular embodiments are merely illustrative, and not restrictive. For example, although features have primarily been described with respect to growing plants, some features may be adapted to grow, manage or sustain other types of life forms or even non-living systems such as animal, biological, mineral, chemical, mechanical, etc.

Although particular embodiments describe growing one type of plant and administering the same type and amount of materials and conditions within the enclosure to the one plant, other variations are possible. For example, in other embodiments a single enclosure may be adapted to applying different materials and conditions each to a selected one or more of multiple plants by segregating emitter position and sensor sensing. In another approach, multiple varying plants within the enclosure can be subjected to the same materials and conditions and beneficial effects may be realized. Other variations are possible.

Any suitable programming language may be used to implement the routines of particular embodiments including C, C++, Java, assembly language, etc. Different programming techniques may be employed such as procedural or object-oriented. The routines may execute on a single processing device or on multiple processors. Although the steps, operations, or computations may be presented in a specific order, the order may be changed in particular embodiments. In some particular embodiments, multiple steps shown as sequential in this specification may be performed at the same time.

Particular embodiments may be implemented in a computer-readable storage medium (also referred to as a machine-readable storage medium) for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments may be achieved by any means known in the art. Distributed, networked systems, components, and/or circuits may be used. Communication or transfer of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that is stored in a machine-readable medium to permit a computer to perform any of the methods described above.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, they are intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. An apparatus for growing a plant, the apparatus comprising an enclosure;
a sensor for sensing a condition of a plant inside the enclosure;
a dispenser for applying a material to the plant;
a receptacle associated with the enclosure and coupled to the dispenser for dispensing the material to the plant; and
a communication module for transmitting the sensor signal over the Internet and for receiving a signal from the Internet to control dispensing of the material to the plant in response to the sensor signal.

2. The apparatus of claim 1, wherein the sensor signal is conveyed to a human at a remote location.

3. The apparatus of claim 1, wherein the received signal is derived at least in part from a human at a remote location.

4. The apparatus of claim 1, further comprising:
a local controller.

5. The apparatus of claim 4, wherein the local controller receives a profile, wherein the profile includes instructions for dispensing a material to the plant.

6. The apparatus of claim 1, wherein the sensor is inside the enclosure.

7. The apparatus of claim 1, wherein the sensor is outside the enclosure.

8. The apparatus of claim 1, wherein the sensor is powered by a battery.

9. The apparatus of claim 4, wherein the sensor registers with the local controller.

10. The apparatus of claim 1, wherein the dispenser registers with the local controller.

11. The apparatus of claim 1, further comprising:
a cartridge for containing the material, wherein the cartridge is coupled to the receptacle.

12. The apparatus of claim 11, wherein the cartridge is identified automatically at the local controller.

13. The apparatus of claim 11, further comprising:
a keypad for allowing a user to enter information to identify the cartridge.

14. The apparatus of claim 11, wherein an order alert for the cartridge is generated automatically when a material level inside the cartridge reaches a predetermined level.

15. The apparatus of claim 11, wherein one or more of the following is included as information in association with the cartridge: prepared-on date, expiration date, brand, manufacturer, or quantity.

16. The apparatus of claim 11, wherein cartridge information is determined by one or more of optical character recognition (OCR), bar code scanning, radio-frequency identification (RFID), or quick response (QR) code.
